(19) United States
(12) Patent Application Publication
(10) Pub. No.: US 2006/0182921 A1
(43) Pub. Date: Aug. 17, 2006

(54) Tape cassette and printing tape accommodated therein

(75) Inventors: Hitomi Hioki, Nagoya-shi (JP); Toshio Takahashi, Nagoya-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 11/332,254

(22) Filed: Jan. 17, 2006

(30) Foreign Application Priority Data
Feb. 17, 2005 (JP) 2005-040178

(51) Int. Cl. B32B 33/00

(52) U.S. Cl. 428/40.1

(57) ABSTRACT

A tape cassette includes: a casing; and a printing tape accommodated in the casing. The printing tape includes: a main sheet member; an adhesive; and a release sheet. The main sheet member is made of a paper material and is elongated in its longitudinal direction. The adhesive is provided on one surface of the main sheet member. The adhesive is either alkali-soluble or water-soluble. The release sheet is separably bonded to the one surface of the main sheet member via the adhesive.

### TECHNICAL FIELD

The present invention relates to a tape cassette accommodating a printing tape, and the printing tape.

### BACKGROUND

A conventional printing tape accommodated in a tape cassette for a tape printer and the like is configured of a base material having a printing surface and an adhesive surface, an adhesive coated on the adhesive surface of the base material, and a release sheet that is separably bonded to the adhesive surface of the base material via the adhesive. This printing tape is accommodated in the tape cassette, which serves as a casing. When this type of printing tape is pulled from the tape cassette, an ink ribbon is superimposed over the printing surface of the base material, and a printing mechanism of a tape printer, including a thermal head, platen, and the like, prints on the printing surface of the base material. Subsequently, the printed tape is cut to a prescribed length to be used as a strip-like printing label that can be fixed to paper files, notebooks, and other stationery materials, for example.

The conventional printing tapes, however, cannot be recycled.

More specifically, the base material of the conventional printing tapes is generally made from a resin film that is waterproof and the like. Accordingly, the base material cannot be recycled.

Most adhesives applied to the surface of the base material are neither water-soluble nor alkali-soluble. Accordingly, printing tapes using this type of adhesive cannot be recycled.

The peeling sheet is generally formed of a resin film or a paper with a resin film being laminated thereon. The peeling sheet formed of a resin film cannot be recycled. The peeling sheet formed of a paper with a resin film being laminated thereon cannot be recycled, either.

Therefore, when disposing a paper file or the like on which a printing label has been applied, it is necessary to peel the printing label from the paper file, which is extremely inconvenient.

Japanese unexamined utility model application publication NO. HEI-7-27837 has proposed a release sheet that is separably bonded, via adhesive, to a processed good, such as a seal, a sticker, a label, or a wall paper. The release sheet has a paper-based material. A sealing layer for preventing a release agent from permeating the paper material is provided on at least one surface of the paper base material. A release layer formed of the release agent is then provided on the sealing layer. The peeling sheet can be recycled because a phenolic, epoxy, or acrylic resin is used as the sealing layer.

### SUMMARY

It is conceivable to apply the peeling sheet of the Japanese unexamined utility model application publication NO. HEI-7-27837 as the peeling sheet for the printing tape. In this conceived printing tape, however, only the peeling sheet can be recycled. Accordingly, when disposing the printing tape, the recyclable peeling sheet has to be separated from the label and the adhesive layer.

In view of the foregoing, it is an object of the present invention to provide a tape cassette employing a recyclable printing tape and the recyclable printing tape.

In order to attain the above and other objects, the present invention provides a tape cassette, including: a casing; and a printing tape accommodated in the casing. The printing tape includes: a main sheet member; an adhesive; and a release sheet. The main sheet member is made of a paper material and is elongated in its longitudinal direction. The adhesive is provided on one surface of the main sheet member. The adhesive is either alkali-soluble or water-soluble. The release sheet is separably bonded to the one surface of the main sheet member via the adhesive.

According to another aspect, the present invention provides a printing tape, including: a main sheet member; an adhesive; and a release sheet. The main sheet member is made of a paper material and is elongated in its longitudinal direction. The adhesive is provided on one surface of the main sheet member. The adhesive is either alkali-soluble or water-soluble. The release sheet is separably bonded to the one surface of the main sheet member via the adhesive.

### BRIEF DESCRIPTION OF THE DRAWINGS

The particular features and advantages of the invention as well as other objects will become apparent from the following description taken in connection with the accompanying drawings, in which:

FIG. 1 is a perspective view of a tape cassette according to one illustrative aspect of the present invention;

FIG. 2 is a plan view of the tape cassette in which an upper case has been removed from a lower case;

FIG. 3 is a perspective view showing the layers of a printing tape;

FIG. 4 is a perspective view showing a method of measuring peel-off force;

FIG. 5 is a table showing the results of first printing confirmation tests;

FIG. 6 is a table showing the results of second printing confirmation tests; and

FIG. 7 is a plan view of the printing tape from the base material side.

### DETAILED DESCRIPTION

A tape cassette and a printing tape according to one illustrative aspect of the invention will be described with reference to the accompanying drawings.

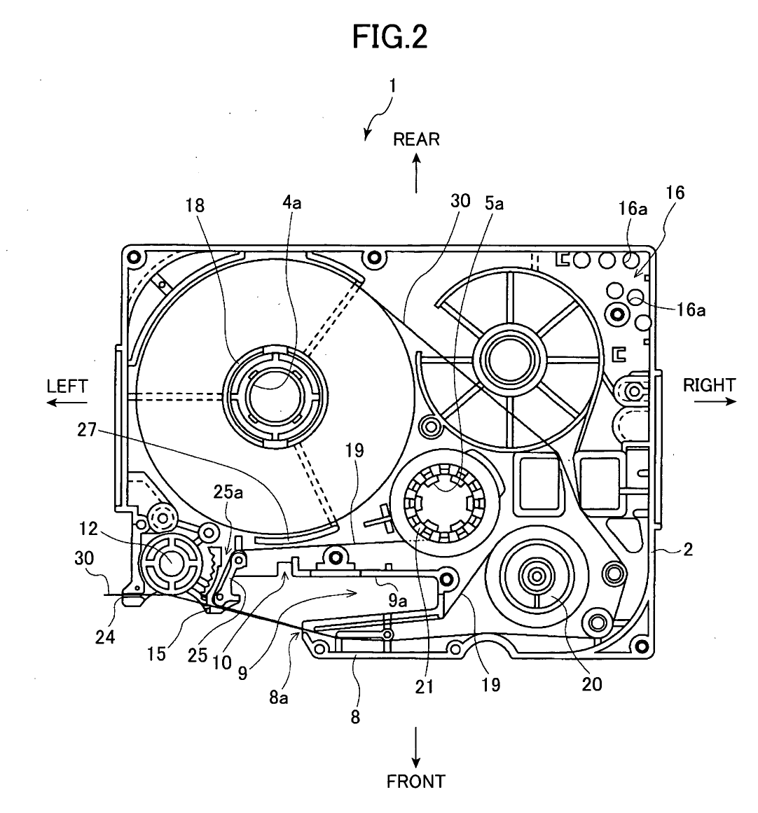

The tape cassette 1 according to the illustrative aspect is detachably mounted in a tape printer (not shown). As shown in FIG. 2, the tape cassette 1 accommodates a recyclable printing tape 30 according to the illustrative aspect. The printing tape 30 can be disposed along with a burnable material, to which the printing tape 30 is affixed, and is therefore recyclable.

First, the overall structure of the tape cassette 1 will be described.

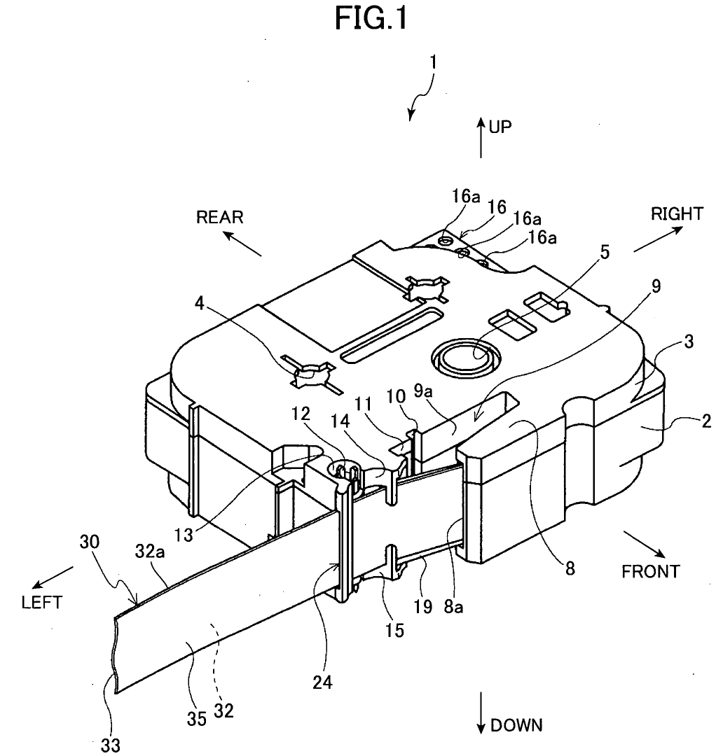

In the following description, the right lower side of the tape cassette 1 in FIG. 1 will be referred to as the “front side,” while the left upper side will be referred to as the “rear side.” The right upper side of the tape cassette 1 in FIG. 1 will be referred to as the “right side,” while the left lower side will be referred to as the “left side.” The upper side of the tape cassette 1 in FIG. 1 will be referred to as the “upper side,” while the lower side will be referred to as the “lower side.”

The tape cassette 1 shown in FIG. 1 is detachably mounted in a tape printer. The tape cassette 1 includes a lower case 2, and an upper case 3 fixed to the upper side of the lower case 2.

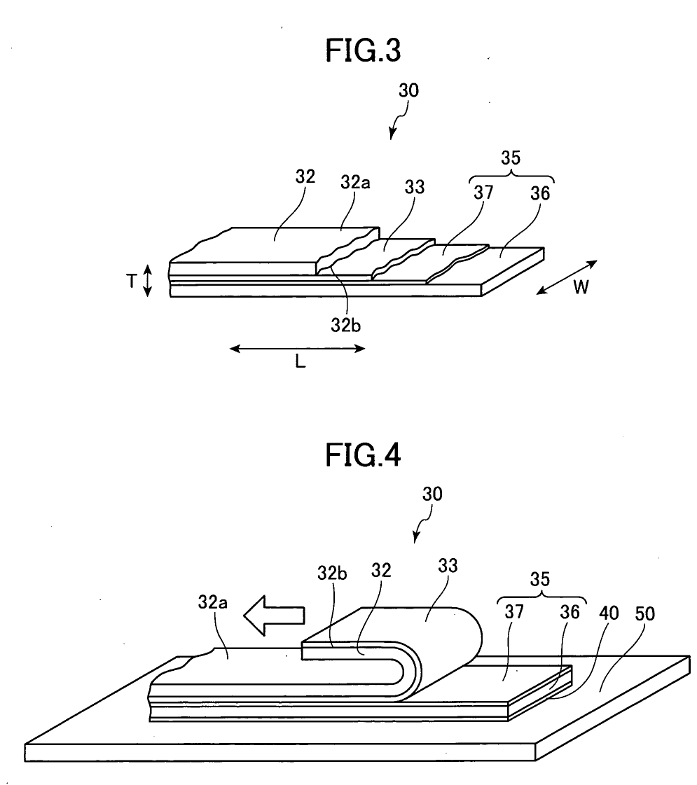

As shown in FIG. 1, support through-holes 4 and 5 are formed in the upper case 3. As shown in FIG. 2, support through-holes 4a and 5a are also formed in the lower case 2 at positions corresponding to and in communication with the support through-holes 4 and 5 of the upper case 3. The upper case 3 and the lower case 2 rotatably support a tape spool 18 (see FIG. 2) at the support through-holes 4 and 4a. The printing tape 30 is wound about the tape spool 18, with a release paper 35 of the printing tape 30 (see FIG. 3) facing outward. The upper case 3 and the lower case 2 rotatably support a ribbon take-up spool 21 (see FIG. 2) at the support through-holes 5 and 5a. The ribbon take-up spool 21 pulls an ink ribbon 19 off a ribbon spool 20 (see FIG. 2) when a thermal head (not shown) in the tape printer is printing text, symbols, graphics, and the like on a base material 32 (see FIG. 3) of the printing tape 30. The ribbon take-up spool 21 takes up the used ink ribbon 19.

As shown in FIG. 1, an arm part 8 is provided on the front side of the tape cassette 1. An opening 8a is formed in the arm part 8. A thermal head accommodating section 9 is provided near the opening 8a of the arm part 8 and is encompassed by the arm part 8 and a wall 9a opposing the arm part 8. The thermal head accommodating section 9 is an opening provided for mounting the thermal head, platen, and the like (none of which are shown) of the tape printer when the tape cassette 1 is mounted in the tape printer. The printing tape 30 pulled off the tape spool 18 and the ink ribbon 19 pulled off the ribbon spool 20 are sent out together through the opening 8a from the arm part 8 to the thermal head accommodating section 9.

A first engaging part 10 extending vertically in FIG. 1 along the thickness of the tape cassette 1 is formed as a recessed part in the wall 9a that is recessed farther rearward than the wall 9a. A second engaging part 11 is formed in a left side wall of the thermal head accommodating section 9 as a recessed part that is recessed in a direction along the wall 9a orthogonal to the recessed direction of the first engaging part 10. The first and second engaging parts 10 and 11 engage with two respective protruding parts formed on a thermal head holder (not shown) that supports the thermal head of the tape printer. With this construction, the thermal head can be reliably mounted in the thermal head accommodating section 9 without interference from the printing tape 30 and the ink ribbon 19.

As shown in FIG. 1, a support through-hole 13 is formed at a location downstream of the thermal head accommodating section 9 in the conveying direction of the printing tape 30 and ink ribbon 19. The support through-hole 13 extends vertically in FIG. 1 through the thickness of the tape cassette 1. A tape-feeding roller 12 is rotatably supported in the tape cassette 1 inside the support through-hole 13. The tape-feeding roller 12 pulls the printing tape 30 off of the tape spool 18 (see FIG. 2) in cooperation with a pressure roller (not shown), which is mounted in the tape printer and which is disposed in opposition to the tape-feeding roller 12.

A pair of upper and lower restricting members 14 and 15 is provided near the tape-feeding roller 12 on the upstream side of the tape-feeding roller 12 in the conveying direction of the printing tape 30. The upper and lower restricting members 14 and 15 restrict the printing tape 30 from moving in the widthwise direction of the printing tape 30 (thickness direction of the tape cassette 1) at a position downstream of the thermal head, while guiding the printing tape 30 toward a tape discharge opening 24. Hence, the upper and lower restricting members 14 and 15 restrict movement of a portion of the printing tape 30 that has been printed with text and the like. As shown in FIG. 2, a guide member 25 is provided on the inside of the upper and lower restricting members 14 and 15. The guide member 25 is for separating the used ink ribbon 19 from the printing tape 30 as the ink ribbon 19 is conveyed through the thermal head accommodating section 9, and for guiding the ink ribbon 19 to the ribbon take-up spool 21. A guide opening 25a is formed along the guide member 25. The used ink ribbon 19 passes through the guide opening 25a.

As shown in FIGS. 1 and 2, a cassette detection part 16 is formed in the right rear corner of the tape cassette 1. A plurality of switch through-holes 16a forming a prescribed pattern penetrates the cassette detection part 16, enabling the type of tape cassette 1 to be detected. Here, the type of tape cassette 1 indicates the width of the printing tape 30, ink color applied to the ink ribbon 19, and the like. The switch through-holes 16a are formed in different patterns for different types of the tape cassette 1. A plurality of detection switches (not shown) is provided inside the tape printer for detecting the type of the tape cassette 1 by generating ON/OFF signals. The combination of the ON/OFF signals indicates the type of the tape cassette 1.

Next, the internal structure of the tape cassette 1 will be described. As shown in FIG. 2, the tape spool 18 is disposed in the left rear corner of the lower case 2. The tape spool 18 is rotatably supported by the lower and upper cases 2 and 3 via the support through-holes 4a and 4. The printing tape 30 is wound about the tape spool 18. The ribbon spool 20 is disposed in the front right side of the lower case 2. The ribbon spool 20 is rotatably supported by the lower case 2. The ink ribbon 19 is wound about the ribbon spool 20. The ribbon take-up spool 21 is disposed at a location between the tape spool 18 and the ribbon spool 20. The ribbon take-up spool 21 is rotatably supported by the lower and upper cases 2 and 3 via the support through-holes 5a and 5. The ribbon take-up spool 21 pulls the ink ribbon 19 from the ribbon spool 20 and takes up the used ink ribbon 19 after text and the like have been printed on the printing tape 30. A clutch spring (not shown) is attached to the lower part of the ribbon take-up spool 21. This clutch spring prevents the ribbon take-up spool 21 from rotating in reverse and allowing the ink ribbon 19 from going slack.

A prescribed gap is formed between the printing tape 30 wound around the tape spool 18 and the used ink ribbon 19 that passes through the guide opening 25a and that is taken up by the ribbon take-up spool 21, so that the ink ribbon 19 and printing tape 30 do not contact each other. A separating wall 27 is erected in this gap.

Next, the printing tape 30 will be described.

As shown in FIG. 3, the printing tape 30 is configured of: the long, strip-like base material 32 having a pair of opposite surfaces 32a and 32b; an adhesive layer 33 applied to the surface 32b of the base material 32; and the long, strip-like release paper 35 that is separably bonded to the surface 32b of the base material 32 via the adhesive layer 33. The surface 32a of the base material 32 serves as a printing surface. That is, the printing mechanism of the tape printer (thermal head, platen, and the like) prints text, symbols, and graphics on the printing surface 32a.

The printing tape 30 is elongated in its longitudinal direction L, has a width in a widthwise direction W that is perpendicular to the longitudinal direction L, and has a thickness in a thickness direction T, in which the base material 32, adhesive layer 33, and release paper 35 are laminated.

The base material 32 shown in FIG. 3 is a paper material formed from wood chips and recycled waste paper. The wood chips are formed from wood ground up into small pieces. The base material 32 is produced through a process described below. This process is the same as the common process of producing recycled paper from waste paper.

First, a wood pulp is created by boiling the wood chips together with chemicals to remove fiber from the wood.

A waste paper pulp is created by decomposing the waste paper into a fibrous form, performing processes to remove ink, dust, and the like from the decomposed paper, and performing processes to bleach the fibrous paper after the ink and the like has been removed. It is noted that during the removing process, the waste paper is mixed in warm water, caustic soda, deinking agent, and the like. Accordingly, when the paper is converted to a fibrous state, the ink is separated from the paper fibers.

The waste paper content in the base material 32 can be adjusted by adjusting the amounts of wood pulp and waste paper pulp based on the strength and whiteness required for the base material 32. In this illustrative aspect, there is no particular restriction on the content of waste paper in the base material 32. The base material 32 formed of paper in this way can be recycled by using the base material 32 as waste paper through the process described above.

The adhesive layer 33 shown in FIG. 3 is formed of an adhesive having either one of the properties of water-solubility and alkali-solubility. In other words, the adhesive layer 33 is formed of a water-soluble adhesive or an alkali-soluble adhesive. One example of the water-soluble adhesive is Cevian A-866 manufactured by Daicel Chemical Industries, Ltd. An example of the alkali-soluble adhesive is Coponyl N-2584 manufactured by Nippon Synthetic Chemical Industry Co., Ltd.

When the printing tape 30 is processed in the above-described recycling process, when the printing tape 30 is processed as waste paper with warm water and caustic soda, the adhesive of the adhesive layer 33 can be separated along with the ink from the paper fibers.

Since the adhesive layer 33 is formed of an adhesive that can be dissolved by water- or alkali-solutions, the adhesive layer 33 can be easily separated and removed from the paper in the recycling process described above. Accordingly, the printing tape 30 can be discarded with the adhesive layer 33 coated on the base material 32.

The release paper 35 shown in FIG. 3 is configured of: a base material 36 formed of a recyclable paper; and a release layer 37 laminated on one surface of the base material 36 that is bonded to the base material 32. The base material 36 is formed of a recyclable paper, such as glassine, high-grade paper, or kraft paper. The release layer 37 is formed on the base material 36 by applying a release agent to the surface of the base material 36 that is bonded to the adhesive layer 33.

In this illustrative aspect, silicone is used as the release agent. Silicone has a property of being depolymerized in acid or alkali and, hence, is easily depolymerized in the recycling process.

With this construction, the paper base material 36 can be recycled, and the release layer 37 can be easily removed during the recycling process.

It is noted that when the base material 36 is formed of a high-grade paper, kraft paper, or the like, if the release agent is directly applied to the base material 36, the release agent will penetrate into the base material 36. Therefore, an aqueous resin or the like is first applied to the base material 36 as a sealing agent. Then, the silicone release agent is applied on the sealing agent. On the other hand, if the base material is formed of glassine, the sealing agent is not required for the base material 36, and therefore the silicone release agent is applied directly onto the base material 36.

It is noted that the release layer 37 is formed simply by coating the surface of the base material 36 with a minute amount of release agent, i.e., less than about 1 g/m². Therefore, the release agent is not likely to have much effect on the recycling process, even if the release agent is formed of a material, other than silicone, that does not change in the presence of acid or alkali.

In the printing tape 30 according to this illustrative aspect, the adhesive force of the adhesive layer 33 is regulated so that the printing tape 30 has a 180° peel-off force of at least 0.18 N when the printing tape 30 has a width of 50 mm. In other words, the adhesive force of the adhesive layer 33 is regulated to attain the 180° peel-off force of at least 0.18 [N/50 mm].

Here, the “peel-off force” for the printing tape 30 is defined as the force required to peel the release paper 35 off the adhesive layer 33 provided on the surface 32b of the base material 32. Especially, the “180° peel-off force” for the printing tape 30 is defined as the force required to peel the release paper 35 off the adhesive layer 33 by pulling one end of the base material 32 in the longitudinal direction L of the printing tape 30 backward 180° so that the base material 32 is bent in a U-shape as shown in FIG. 4.

The 180° peel-off force for the printing tape 30 is proportional to the width of the printing tape 30. Accordingly, the 180° peel-off force of 0.18 N for the width of 50 mm is equivalent to the 180° peel-off force of 0.086 N for the width of 24 mm. Thus, it can be said that the adhesive force of the adhesive layer 33 is regulated to attain a 180° peel-off force of at least 0.086 [N/24 mm]. In other words, the adhesive force of the adhesive layer 33 is regulated to attain a 180° peel-off force of at least 0.086 N when the printing tape 30 has a width of 24 mm.

With the above-described specification, the printing tape 30 attains advantages described below.

The printing tape 30 has the paper base material 32 and is therefore stiffer than conventional printing tapes that have films as the base material. Since the base material 36 of the release paper 35 is also made of paper, the overall stiffness of the printing tape 30 is even greater. It is noted that as the stiffness increases, the resiliency increases and becomes unlikely to crease. Accordingly, when this printing tape 30 is conveyed along the conveying path that bends several times in the tape cassette 1 as shown in FIG. 2, the difference in the stiffness of the base material 32 and the base material 36 of the release paper 35 will be manifested as strain on the adhesive layer 33. If the adhesive force of the adhesive layer 33 is too weak, the adhesive layer 33 cannot withstand this strain. Consequently, gaps will be generated between the adhesive layer 33 and the release paper 35 at multiple locations, producing what is called “floating” at multiple places. When floating is produced in the printing tape 30, the thickness of the printing tape 30 will become irregular. As a result, the printing mechanism of the tape printer cannot print cleanly, particularly at the places that floating occurs, resulting in faint or patchy text and the like.

Contrarily, according to this illustrative aspect, with the above-described specifications, the adhesive layer 33 can withstand strain produced by the difference in stiffness of the base material 32 and release paper 35, thereby preventing floating from occurring between the release paper 35 and the adhesive layer 33 provided on the base material 32. The basis of restricting values of 180° peel-off force in the printing tape 30 is derived from first printing confirmation tests conducted on printing tapes having different peel-off forces. Results of the first printing confirmation tests will be described in detail later.

Additionally, according to this illustrative aspect, the thickness of each of the base material 32, adhesive layer 33, and release paper 35 is regulated so that the overall thickness of the printing tape 30 is no greater than 200 μm.

With the above-described specification, the printing tape 30 attains advantages described below.

As described above, the printing tape 30 includes the paper base material 32 and is therefore stiffer than the conventional printing tapes that include films as the base material. Further, since the base material 36 of the release paper 35 is also paper, the printing tape 30 is stronger and has a greater overall stiffness. If the printing tape 30 has a too large thickness, when this printing tape 30 is conveyed to the thermal head accommodating section 9 via the opening 8a of the arm part 8 shown in FIG. 1 and supplied to the printing mechanism of the tape printer (that is, between the thermal head and the platen), the base material 32 of the printing tape 30 will contact the thermal head with the ink ribbon 19 interposed therebetween and will apply excessive pressure to the thermal head. Under these conditions, it will be difficult to properly transfer text and the like to the base material 32 of the printing tape 30 through thermal transfer. The printed text and the like will be faint or patchy.

Contrarily, according to this illustrative aspect, limiting the thickness of the printing tape 30 as described above prevents the stiffness of the overall printing tape 30 from exceeding a prescribed level at which the printing tape 30 presses excessively against the thermal head. Therefore, this construction can prevent faint or patchy text and the like from being printed on the base material 32. The basis for restricting the thickness of the printing tape 30 is derived from second printing confirmation tests conducted on printing tapes having different thicknesses. The results of the second printing confirmation tests will be described in detail later.

Next, the first printing confirmation tests will be described. The first printing confirmation tests are conducted to verify the relationship between the peel-off force of the printing tape 30 and the printing condition.

The testing method will be described next.

First, a plurality of printing tapes 30, each having a different peel-off force, was prepared.

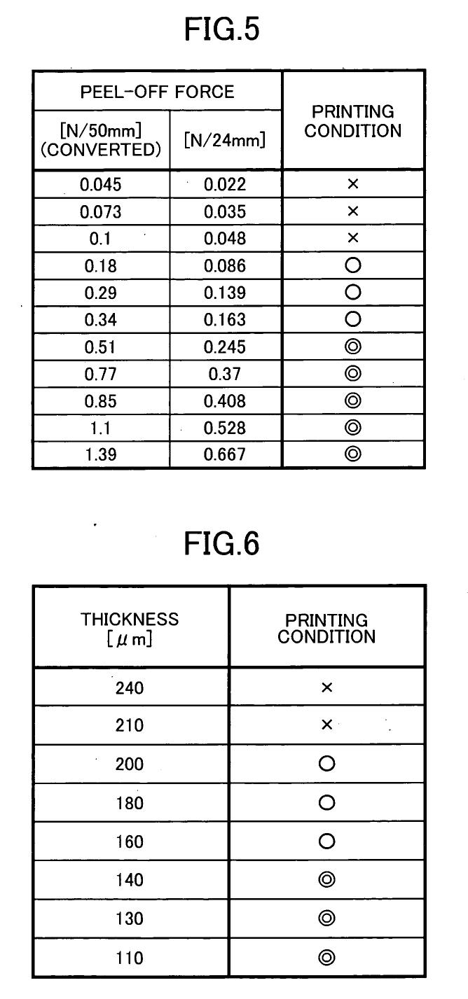

To do this, numerous printing tapes 30 having a 24-mm width, a 110-μm thickness, and an unknown peel-off force were prepared. The peel-off force of each was measured, and eleven of the printing tapes 30 having a peel-off force within the range 0.022-0.667 N ([N/24 mm]) were selected as samples (see FIG. 5).

More specifically, numerous printing tapes 30 that have glassine as the base material 36 of the release paper 35, that have a 110-μm thickness, and that have unknown peel-off forces were prepared. Each printing tape 30 was cut to a width of 24 mm and a length of 160 mm. As shown in FIG. 4, the release paper 35 side of the printing tape 30 was fixed to a stainless steel plate 50 by a double-sided tape 40. Next, one end of the base material 32 was pulled backward 180° and peeled off the release paper 35 with a pulling rate of 300 mm/min. The resisting force was measured at this time. Measurements of the resisting force were achieved using a peel-off force measuring device (Strograph M-50 manufactured by Toyo Seiki Seisaku-sho). Based on the measurement results, among all the printing tapes 30, eleven printing tapes 30 that have a peel-off force within the range 0.022-0.667 [N/24 mm] were selected as samples as shown in FIG. 5.

Next, the eleven samples were each loaded in the tape cassette 1 shown in FIG. 1 and subjected to continuous printing by the tape printer. The printing mechanism of the tape printer used for this experiment had a printing density of 360 dpi and a platen pressure of 3.5-4.3 kgf. During the printing operation, floating produced in the printing tape 30 and the condition of text and the like printed on the base material 32 were comprehensively evaluated. The method of evaluation entailed assigning a ⊚ mark when no floating occurred and the printing condition was satisfactory; assigning a ◯ mark when floating occurred in some locations but did not affect the printing condition; and assigning a X mark when floating frequently occurred and adversely affected the printing condition. Based on this evaluation, the marks ⊚ and ◯ denote a passing mark, and the X mark denotes a failure.

Next, the results of the first printing confirmation tests will be described with reference to FIG. 5.

Of the eleven samples with the width of 24 mm, samples having a 180° peel-off force of 0.245-0.667 N produced no floating and achieved satisfactory printing quality and, therefore, received a ⊚ mark. Samples having a 180° peel-off force of 0.086-0.163 N produced floating in some locations but not enough to adversely affect the printing quality and, therefore, received a ◯ mark. However, samples having a 180° peel-off force of 0.022-0.048 N produced floating in numerous locations that adversely affected printing conditions in the form of faint and patchy text and the like and, therefore, received an X mark.

From the above results, we can see that sufficient printing quality can be achieved in a stiff printing tape 30 having a width of 24 mm, provided that the printing tape 30 has a 180° peel-off force of greater than or equal to 0.086 N, that is, the passing level of ◯ or ⊚.

It is noted that the 180° peel-off force for the printing tape 30 is proportional to the width of the printing tape 30. The above results of the 180° peel-off force [N/24 mm] for the printing tape having a width of 24 mm are converted through calculation to a 180° peel-off force [N/50 mm] for a printing tape 30 having a width of 50 mm, and are indicated also in FIG. 5. It is therefore known that for printing tapes 30 having a width of 50 mm, those printing tapes 30 with a 180° peel-off force of 0.51-1.39 N will receive the ⊚ mark; printing tapes 30 having a 180° peel-off force of 0.18-0.34 N will receive a ◯ mark; and printing tapes 30 having a 180° peel-off force of 0.045-0.1 N will receive a X mark. Accordingly, the stiff printing tape 30 having a width of 50 mm can maintain sufficient printing quality, provided that the 180° peel-off force is greater than or equal to 0.18 N, that is, a passing level of ◯ or ⊚.

In this way, a study was performed only on the printing tapes 30 having a width of 24 mm. However, it is possible to obtain the relationship between the 180° peel-off force and printing quality of printing tapes 30 having other widths (for example, 12 or 18 mm) by simply converting, through calculation, the results found in the tests in proportion to the width of the printing tape 30.

The second printing confirmation tests will be described next. The second printing confirmation tests were conducted to confirm the relationship between the thickness and printing quality of the printing tape 30.

Next, the method of testing will be described.

First, a lot of printing tapes 30, each with a different thickness, was prepared.

Next, each of the printing tapes 30 was cut to a width of 18 mm, and measured for the thickness and the 180° peel-off force. The 180° peel-off force was measured in the same manner as in the first printing confirmation tests.

Then, of all the printing tapes 30, eight samples (see FIG. 6) having thicknesses between 110-240 μm and having the 180° peel-off force of the same value of 0.288 [N/18 mm] (that is, 0.80 [N/50 mm]) were selected. Each of the eight printing tapes 30 had a different thickness.

Next, the eight samples were each loaded into the tape cassette 1 and subjected to continuous printing by a tape printer. The printing mechanism of the tape printer used for this experiment had the same printing density and the same platen pressure as in the first printing confirmation test. During the printing operation, floating produced in the printing tape 30 and the condition of text and the like printed on the base material 32 were comprehensively evaluated. The method of evaluations entailed marking a ⊚ when no floating occurred and the printing quality was satisfactory; marking a ◯ when floating occurred in a few places but had no effect on printing quality; and marking an X when floating occurred frequently and adversely affected printing quality, whereby ⊚ and ◯ denote passing marks, and X denotes a failure.

Next, the results of the second printing confirmation tests will be described. Of the eight samples shown in FIG. 6, samples having a thickness of 110-140 μm produced no floating and achieved sufficient printing quality and, therefore, were given the ⊚ mark. Samples having a thickness 160-200 μm produced floating in a few locations, but the floating showed no effect on printing quality and, hence, the samples were assigned the ◯ mark. However, samples having a thickness of 210-240 μm produced much floating that had an adverse effect on printing quality in the form of faint text and the like and, therefore, these samples were assigned the X mark.

These results show that the stiffness (elastic force) of the printing tape 30 can be restrained to a degree that prevents the printing tape 30 from pushing the thermal head excessively, providing that the thickness of the printing tape 30 is no greater than 200 μm, that is, a passing level of ◯ or ⊚.

Since both the base material 32 and release paper 35 are stiff sheets formed of paper, the thickness of either can be adjusted without affecting printing quality. Therefore, the overall thickness of the printing tape 30 can be adjusted by adjusting the thickness of the base material 32, the thickness of the release paper 35, or the thickness of both the base material 32 and release paper 35.

According to this illustrative aspect, information in the form of at least one of text, symbols, and graphics is provided on the printing tape 30 to indicate that the printing tape 30 is recyclable.

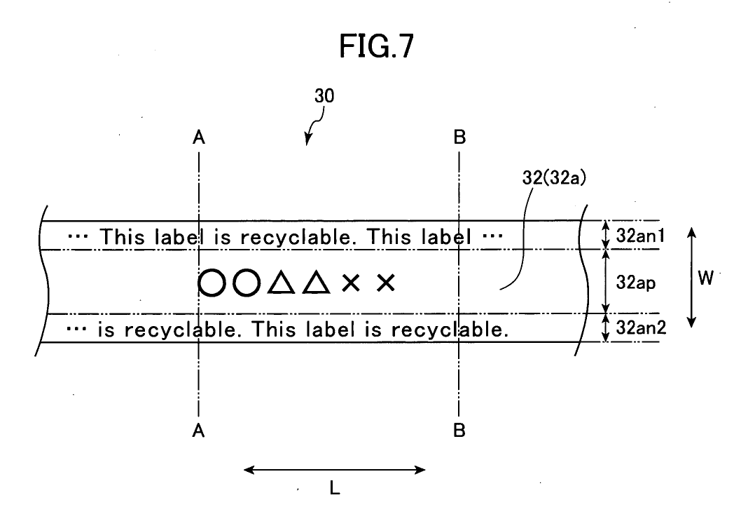

More specifically, as shown in FIG. 7, the printing surface 32a of the base material 32 is divided into: a printing region 32ap that is provided in the widthwise center and that extends along the length of the base material 32; and a pair of non-printing regions 32an1 and 32an2 that are provided on both widthwise sides of the printing region 32a on both widthwise edges of the base material 32.

According to this illustrative aspect, at least one of text, symbols, and graphics informing the user that the printing tape 30 is recyclable are displayed in the non-printing regions 32an1 and 32an2 where the printing mechanism does not print. By reading the information displayed in the non-printing regions 32an1 and 32an2 of the printing tape 30, the user can quickly determine that the printing tape 30 is recyclable. Examples of text, symbols, and graphics used to inform the user that the printing tape 30 is recyclable include the text “This label is recyclable” shown in FIG. 7, and a logo graphic such as the EcoMark. The information provided in the non-printing regions 32an1 and 32an2 need not be printed, but can instead be imprinted or engraved therein, or fixed or attached thereon.

As also shown in FIG. 7, the printing mechanism of the tape printer prints text and the like, such as “◯◯ΔΔXX”, in the printing region 32ap of the base material 32. By displaying at least one of text, symbols, and graphics informing the user that the printing tape 30 is recyclable in the non-printing regions 32an1 and 32an2 separate from the printing region 32ap, the text and the like in the non-printing regions 32an1 and 32an2 are not overlapped by text and the like printed in the printing region 32ap.

As shown in FIG. 7, text and the like are displayed in one non-printing region 32an1 on one widthwise edge of the base material 32 (hereinafter referred to as the “upper edge”) and in another non-printing region 32an2 on another widthwise edge opposite the first edge (hereinafter referred to as the “lower edge”) at positions offset from each other in the longitudinal direction of the base material 32. In the example shown in FIG. 7, the text “This label is recyclable” is displayed in both non-printing regions 32an1 and 32an2 of the base material 32 such that the start position of the text beginning with “This . . . ” displayed in the non-printing region 32an1 in the upper edge of the base material 32 is offset in the longitudinal direction of the base material 32 from the starting position of the text displayed in the non-printing region 32an2 in the lower edge.

If the printing tape 30 is cut at a prescribed length along lines A-A and B-B shown in FIG. 7, for example, the beginning portion of the text displayed in the non-printing region 32an1 on the upper edge “This label . . . ” is cut off, making it difficult for the user to understand the intended meaning of the text simply by looking at the text displayed in this region. Hence, the text does not sufficiently indicate to the user that the label is recyclable. However, since the beginning portion “This label . . . ” has not been cut off in the non-printing region 32an2 on the lower edge, the meaning of the text and the like displayed in the pair of non-printing regions 32an1 and 32an2 combined can be reliably conveyed to the user. The same effect can also be inspected when displaying graphical logos, such as the EcoMark.

As described above, the tape cassette 1 according to this illustrative aspect accommodates a recyclable printing tape 30. The printing tape 30 is configured of the paper base material 32, the adhesive layer 33 that can be dissolved in an aqueous solution or an alkaline solution, and the release paper 35 having the paper base material 36. With this construction, the entire printing tape 30 can be recycled. Therefore, if the printing tape 30 is fixed to a file or similar stationery product, the entire file and printing tape 30 can be disposed together, thereby eliminating the inconvenience of separating the label from the file.

Further, since both the base material 32 and release paper 35 are composed of paper, the overall printing tape 30 is stiff, giving rise to the danger that floating may occur between the release paper 35 and adhesive layer 33 provided on one surface of the base material 32. However, by regulating the 180° peel-off force of the printing tape 30, the adhesive layer 33 can be reliably bonded to the release paper 35, even if the paper base materials 32 and 35 are stiff. By preventing the release paper from floating up from the base material 32, the printing tape 30 will not jam in the tape cassette 1. By suppressing the occurrence of floating, sufficient printing quality can be maintained on the base material 32.

Further, the overall stiffness of the printing tape 30 can be suppressed to a prescribed level by setting the thickness of the printing tape 30 smaller than or equal to 200 μm, thereby preventing a decline in printing quality caused by the printing tape 30 pressing excessively against the thermal head.

Further, at least one of text, symbols, and graphics are displayed in the pair of non-printing regions 32an1 and 32an2 provided on both widthwise edges of the base material 32 to inform the user that the printing tape 30 is recyclable. The position at which the text or the like is displayed in one widthwise edge of the printing tape 30 is offset in the longitudinal direction of the printing tape 30 from the position the text or the like is displayed in the other edge of the base material 32. Therefore, when the printing tape 30 is cut in the widthwise direction to a prescribed length, the meaning of the text or the like displayed in the pair of non-printing regions 32an1 and 32an2 together can be reliably conveyed to the user.

Since the release paper 35 is configured of the base material 36 formed of a paper material and the release agent 37 applied to the surface of the base material 36, and is laminated with no resin film, the entire release paper 35 can be subjected to a recycling process. Since both the base material 32 and the release paper 35 can be recycled, even unused printing tape 30 (i.e., printing tape 30 with the release paper 35 still bonded to the base material 32) can be recycled without being separated from recyclable trash.

Although the present invention has been described with respect to the above aspect, it will be appreciated by one skilled in the art that a variety of changes may be made without departing from the scope of the invention.

For example, the 180° peel-off force of the printing tape 30 was studied for a width of 24 mm in the first printing confirmation test. The 180° peel-off force for printing tapes 30 having other widths, such as 12 mm or 18 mm, can be derived from the measurement results for the printing tape 30 having a width of 24 mm by performing a numerical calculation.

In the illustrative aspect described above, the base material 32 is composed of recycled paper produced from used, waste paper. The base material 36 of the release paper 35 may also be composed of recycled paper produced from used, waste paper. Or, the base material 36 may not be formed of a paper.

The base material 32 may be formed from paper other than the recycled paper.

In the above-described illustrative aspect, at least one of text, symbols, and graphics informing the user that the printing tape 30 is recyclable is displayed in both of the pair of non-printing regions 32an1 and 32an2. However, the at least one of text, symbols, and graphics may be displayed in only one of the pair of non-printing regions 32an1 and 32an2.

In the above-described illustrative aspect, the texts are displayed in the non-printing regions 32an1 and 32an2 such that the start positions of the texts in the pair of non-printing regions 32an1 and 32an2 are offset from each other in the longitudinal direction of the base material 32. However, the start positions of the texts in the non-printing regions 32an1 and 32an2 may not offset from each other in the longitudinal direction of the base material 32.

In the above-described illustrative aspect, the printing surface 32a is divided into the non-printing regions 32an1 and 32an2 and the printing region 32ap. However, the printing surface 32a may not have the non-printing regions 32an1 and 32an2. The entire area of the printing surface 32a may be used as the printing region 32ap. Even in this case, at least one of text, symbols, and graphics informing the user that the printing tape 30 is recyclable can be provided in at least one of the pair of widthwise edges of the printing surface 32a.

What is claimed is:

1. A tape cassette, comprising:
a casing; and
a printing tape accommodated in the casing, the printing tape comprising:
a main sheet member that is made of a paper material and that is elongated in its longitudinal direction;
an adhesive provided on one surface of the main sheet member, the adhesive being either alkali-soluble or water-soluble; and
a release sheet separably bonded to the one surface of the main sheet member via the adhesive.

2. The tape cassette as claimed in claim 1, wherein the release sheet comprises:
a paper base member; and
a release agent coated on one surface of the paper base member that is bonded to the main sheet member via the adhesive.

3. The tape cassette as claimed in claim 2, wherein the release sheet is attached to the main sheet member via the adhesive, with a 180° peel-off force of at least 0.18 N/50 mm being required to peel the release paper off the main sheet member.

4. The tape cassette as claimed in claim 2, wherein he the release sheet is attached to the main sheet member via the adhesive, with a 180° peel-off force of at least 0.086 N/24 mm being required to peel the release paper off the main sheet member.

5. The tape cassette as claimed in claim 1, wherein the printing tape is no more than 200 μm thick.

6. The tape cassette as claimed in claim 1, wherein the main sheet member has another surface opposite to the one surface, on which the adhesive is provided, the another surface having two side edges in a widthwise direction thereof; and
at least one of text, symbols, and graphics indicating that the printing tape is recyclable is provided on at least one of the side edges.

7. The tape cassette as claimed in claim 6, wherein the at least one of text, symbols, and graphics are provided in a non-printing region on the another surface of the main sheet member, the non-printing region being separate from a printing region on the another surface.

8. The tape cassette as claimed in claim 6,
wherein the at least one of text, symbols, and graphics indicating that the printing tape is recyclable is provided in both of the two side edges on the another surface, and
wherein the at least one of text, graphics, and symbols provided on one widthwise edge of the base material is offset in the longitudinal direction of the main sheet member from the at least one of text, symbols, and graphics provided on the other edge.

9. The tape cassette as claimed in claim 1, wherein the main sheet member is formed from a recycled paper.

10. A printing tape, comprising:
a main sheet member that is made of a paper material and that is elongated in its longitudinal direction;
an adhesive provided on one surface of the main sheet member, the adhesive being either alkali-soluble or water-soluble; and
a release sheet separably bonded to the one surface of the main sheet member via the adhesive.

11. The printing tape as claimed in claim 10, wherein the release sheet comprises:
a paper base member; and
a release agent coated on one surface of the paper base member that is bonded to the main sheet member via the adhesive.
